(19) United States
(12) Patent Application Publication
(10) Pub. No.: US 2006/0078057 A1
(43) Pub. Date: Apr. 13, 2006

(54) Broadcasting receiving apparatus and method of producing reference signal using the same

(75) Inventor: Kenji Yoshida, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/221,899

(22) Filed: Sep. 9, 2005

(30) Foreign Application Priority Data
Sep. 27, 2004 (JP) 2004-279923

(51) Int. Cl. H04B 1/66

(52) U.S. Cl. 375/240.28

(57) ABSTRACT

To provide a broadcasting receiving apparatus including a receiving section configured to receive a digital broadcasting signal, a processing section configured to recover and reproduce a program from the digital broadcasting signal received by the receiving section, a display section configured to display the program recovered by the processing section, a PCR processing section configured to extract a PCR value from a TS signal, a phase comparing section so that the PCR value extracted from the PCR processing section is compared to a counter value of 42 bits, a PWM generating section that is configured so that the phase difference from the phase comparing section to generate a PWM value, and a memory configured to store the PWM value generated by the PWM generating section therein.

### CROSS-REFERENCE TO RELATED APPLICATIONS

This application is based upon and claims the benefit of priority from prior Japanese Patent Application No. 2004-279923, filed Sep. 27, 2004, the entire contents of which are incorporated herein by reference.

### BACKGROUND OF THE INVENTION

1. Field of the Invention

The present invention relates to a broadcasting receiving apparatus of receiving a TV broadcasting or the like and a method of producing a reference signal using the same.

2. Description of the Related Art

As is well known, in recent years, digitalization of the TV broadcasting has been promoted. For example, in Japan, not only a satellite digital broadcasting such as a BS (broadcasting satellite) digital broadcasting and a 110-degree CS (communication satellite) digital broadcasting but also a digital terrestrial broadcasting has been started.

Then, according to a digital broadcasting receiving apparatus of receiving such a digital television broadcasting, for example, by connecting a high-capacity digital recording device such as an HDD (hard disk drive) thereto, it is possible to record the received program digitally and reproduce the recorded program.

Further, in the present day, with respect to one digital broadcasting receiving apparatus, by connecting a plurality of digital recording devices and making it into a network, it is possible for the digital broadcasting receiving apparatus to designate an arbitrary digital recording device so that the designated digital recording device can record the program or designate an arbitrary digital recording device so that the designated digital recording device can reproduce the program.

In the meantime, according to such a digital broadcasting receiving apparatus making it possible to network-connect a plurality of digital recording devices, a user can easily manage the program recorded in each digital recording device and it is important to retrieve a desired recorded program rapidly and reproduce it.

According to Jpn. Pat. Appln. KOKAI Publication No. 10-136275, there is disclosed a configuration that a television receiving apparatus provided with an Internet receiving function can recognize a connection condition by a phone line even when a speaker outputs a voice of a television signal.

Such a digital broadcasting receiving apparatus processes an analog signal such as an analog broadcasting because the current analog broadcasting is to be continued till 2011. In order for the digital broadcasting receiving apparatus to make the analog broadcasting viewable, at first, encoding an analog signal into an MPEG (moving picture experts group) 2 and decoding the encoded signal, and then, the analog signal becomes viewable by carrying out the imaging processing.

In order to encode such an analog signal into an MPEG 2 once, for example, in the case of MPEG-TS (transport stream) recording, it is necessary to satisfy a standard of MPEG 27 MHz±30 ppm.

In the case of the digital broadcasting, the digital signal is encoded in accordance with this standard at the broadcast station, and upon decoding, the signal is tuned from a PCR (program clock reference) value to approximately 27.0 MHz by VCXO (voltage controlled crystal oscillator) control.

In the case of the analog broadcasting, since such a PCR value is not set, in order to tune to 27 MHz in the VCXO circuit, an offset value of PWM (pulse width modulation) should be tune to 27.0 MHz while measuring the value.

However, the VCXO circuit has a problem such that an offset value of PWM is different for each apparatus since the oscillation frequency of a crystal oscillator and a load capacity are varied for each apparatus and it is not possible to accurately tune the signal to 27 MHz±30 ppm as a standard value of MPEG.

### BRIEF SUMMARY OF THE INVENTION

According to one aspect of the present invention, there is provided a broadcasting receiving apparatus comprising: a receiving section configured to receive a digital broadcasting signal; a processing section configured to recover and reproduce a program from the digital broadcasting signal received by the receiving section; a display section configured to display the program recovered by the processing section; a PCR processing section configured to extract a PCR value from a TS signal; a phase comparing section that is configured so that the PCR value extracted from the PCR processing section is inputted therein to be compared to a counter value of 42 bits; a PWM generating section that is configured so that the phase difference is inputted from the phase comparing section to generate a PWM value; and a memory configured to store the PWM value generated by the PWM generating section therein.

### BRIEF DESCRIPTION OF THE SEVERAL VIEWS OF THE DRAWING

FIG. 1 is a block diagram explaining a main signal processing system of a digital television broadcasting receiving apparatus according to an embodiment of the present invention;

FIG. 2 is a block diagram explaining a signal processing section and a VCXO oscillation circuit of the digital television broadcasting receiving apparatus according to the embodiment;

FIG. 3 is a flow chart illustrating an adjustment routine of an oscillation frequency of the VCXO oscillation circuit according to the embodiment;

FIG. 4 is a flow chart illustrating the operation of the digital television broadcasting receiving apparatus according to the embodiment upon receiving analog broadcasting;

FIG. 5 is a flow chart illustrating the adjustment routine of the oscillation frequency of the VCXO oscillation circuit according to the embodiment; and

FIG. 6 is a flow chart illustrating the adjustment routine of the oscillation frequency of the VCXO oscillation circuit according to the embodiment.

### DETAILED DESCRIPTION OF THE INVENTION

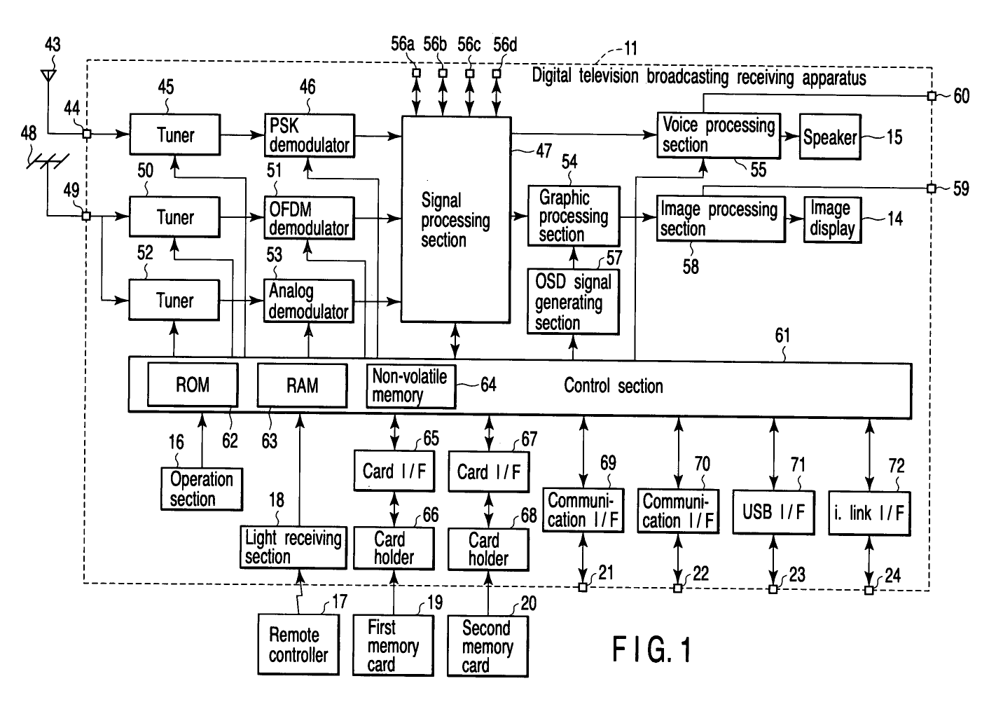

With reference to the drawings, an embodiment of the present invention will be described below. FIG. 1 shows a main signal processing system of a digital television broadcasting receiving apparatus 11 according to an embodiment of the present invention. In other words, a satellite digital television broadcast signal received by an antenna 43 for receiving BS/CS digital broadcasting is supplied to a tuner 45 for a satellite digital broadcasting via an input terminal 44 so that a broadcast signal of a desired channel is selected.

Then, the broadcast signal selected by the tuner 45 is supplied to a PSK (phase shift keying) demodulator 46 to be demodulated to a digital image signal and a digital voice signal and then, this signal is outputted to a signal processing section 47.

In addition, a digital terrestrial television broadcasting signal received by an antenna 48 for receiving a digital terrestrial broadcasting is supplied to a tuner 50 for a digital terrestrial broadcasting via an input terminal 49 so that a broadcast signal of a desired channel is selected.

Then, the broadcast signal selected by the tuner 50 is supplied to an OFDM (orthogonal frequency division multiplexing) demodulator 51 to be demodulated to a digital image signal and a digital voice signal and then, this signal is outputted to the above-mentioned signal processing section 47.

Here, the signal processing section 47 selectively applies predetermined digital signal processing to the digital image signal and the digital voice signal supplied from the PSK demodulator 46 and the digital image signal and the digital voice signal supplied from the OFDM demodulator 51 and outputs these signals to a graphic processing section 54 and a voice processing section 55.

Among these sections, the graphic processing section 54 has a function to superimpose an OSD signal generated by an OSD (on screen display) signal generating section 57 on the digital image signal to be supplied from the signal processing section 47 and output the OSD signal. In addition, the graphic processing section 54 can selectively output the output image signal of the signal processing section 47 and the OSD signal as the output of the OSD signal generating section 57, and can output the combination of the both outputs so that each output configures a half of a screen.

Then, the digital image signal outputted form the graphic processing section 54 is supplied to an image processing section 58. The image processing section 58 converts the inputted digital image signal into the analog image signal of a format capable of being displayed on an image display 14, and it outputs the signal to the image display 14 to be displayed and be guided to the outside via an output terminal 59.

In addition, the voice processing section 55 converts the digital voice signal inputted from the signal processing section 47 into an analog voice signal of a format capable of being reproduced by the speaker 15, and it outputs the signal to the speaker 15 so that the voice of the signal is reproduced to be guided to the outside via an output terminal 60.

Here, in the digital television broadcasting receiving apparatus 11, its all operations including various receiving operations are totally controlled by a control section 61. The control section 61 incorporates a CPU (central processing unit) or the like, receives the operation information from an operation section 16 or the control section 61 receives the operation information transmitted from a remote controller 17 via a light receiving section 18 to control each section so that the content of the operation is reflected on each section.

In this case, the control section 61 mainly uses a ROM (read only memory) 62 in which a control program to be executed by the CPU is stored, a RAM (random access memory) 63 providing an operation area to the CPU, and a non-volatile memory 64 in which various setting information and the control information or the like are stored.

In the control section 61, a first memory card 19 is connected to a wearable card holder 66 via a card I/F (interface) 65. Thereby, the control section 61 can transmit the information to the first memory card 19 fitted to the card holder 66 via the card I/F 65.

In the control section 61, a second memory card 20 is connected to a wearable card holder 68 via a card I/F 67. Thereby, the control section 61 can transmit the information to the second memory card 20 fitted to the card holder 68 via the card I/F 67.

In addition, the control section 61 is connected to a first LAN (local area network) terminal 21 via a communication I/F 69. Thereby, the control section 61 can transfer the information to an HDD associated with the LAN connected to the first LAN terminal 21 via the communication I/F 69. In this case, the control section 61 has a DHCP (dynamic host configuration protocol) server function and controls the operations by allocating an IP (internet protocol) address to the HDD associated with the LAN that is connected to the first LAN terminal 21.

Further, the control section 61 is connected to a second LAN terminal 22 via a communication I/F 70. Thereby, the control section 61 can transmit the information to each device connected to the second LAN terminal 22 (for example, a personal computer, a mobile terminal, and a cellular phone or the like) via a communication I/F 70.

The control section 61 is connected to a USB terminal 23 via a USB (universal serial bus) I/F 71. Thereby, the control section 61 can transmit the information to each device connected to the USB terminal 23 (for example, a personal computer, a mobile terminal, and a cellular phone or the like) via the USB I/F 71.

Further, the control section 61 is connected to an i. Link terminal 24 via an i. Link I/F 72. Thereby, the control section 61 can transmit the information to each device connected to the i. Link terminal 24 (for example, a personal computer, a mobile terminal, and a cellular phone or the like) via the i. Link I/F 72.

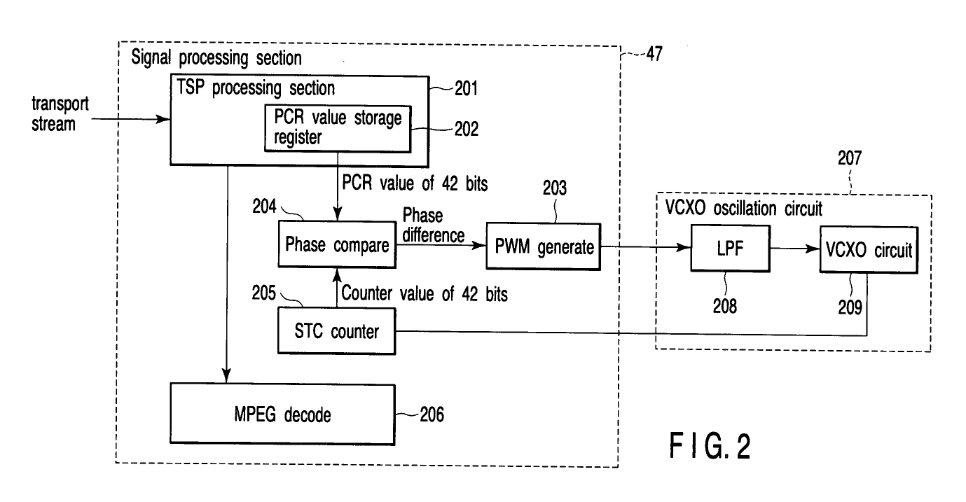

FIG. 2 shows the details of the above-mentioned signal processing section 47. As shown in FIG. 2, a TS (transport stream) signal inputted from a demodulation section of a digital broadcasting wave is inputted in a TSP (transport stream demultiplexing processor) processing section 201 of the signal processing section 47. In the broadcasting wave down converted by a tuner section, a signal of a desired frequency is selected and an I/Q signal is outputted. The I/Q signal outputted from the tuner section is demodulated and its error is corrected by a demodulation section and an MPEG transport stream (TS) is outputted.

In addition, from the TS outputted from the demodulation section, the MPEG-TS separation (TSP) processing section 201 of the signal processing section 47 picks up PES (packetized elementary stream) as the image and voice data encoded from among the TS, the SI (service information) data for displaying the EPG (electronic program guide), and the PCR data as the common clock reference data for synchronizing decoding with display on a screen of each basic stream, and the MPEG-TS separation (TSP) processing section 201 transfers the image and voice data to an MPEG decoding section 206 and transfers the SI data to the RAM 63 as an operation memory to be processed by the CPU of the control section 61.

The PCR data is stored in a PCR value storage register 202 inside the TSP once, and then, the PCR data is transferred to a phase comparing section 204 in order to synchronize the PCR data with an oscillation circuit at the outside.

A phase difference acquired by the phase comparing section 204 is transmitted to a PWM generating section 203 to calculate a pulse period (a period of LOW) of the PWM output and output a rectangular wave of the same period. The outputted rectangular wave is transmitted to an LPF 208 of a VCXO oscillation circuit 207 to be converted into a signal of a DC level. The converted signal of a DC level is transmitted to a VCXO circuit 209 to be used as a reference voltage of the circuit. In the VCXO circuit 209, the oscillation frequency of a basic CLK is changed in accordance with the reference voltage. Here, there is no specific regulation, however, as a variable width of the frequency, a specified value of the MPEG 2 (±30 ppm)+a deviation of a crystal oscillator (±20 ppm)=±100 ppm is assumed.

Subsequently, the CLK (54 MHz or 27 MHz) oscillated by the VCXO circuit 209 is inputted in a STC counter 205 to be converted into the data of 42 bits. The counter value of 42 bits is inputted in the phase comparing section 204 as described above and the phase thereof is compared to that of the PCR value of the digital broadcasting wave.

The PCR value of 42 bits is only acquired when receiving the digital broadcasting, so that when receiving the analog broadcasting, the PWM circuit 203 outputs the data of an initial value. The initial value is converted into a DC value by the LPF 208 to be used as a reference voltage in the VCXO circuit 209. In the VCXO circuit 209, the oscillation frequency is deviated for each unit (a complete product that electronic parts are mounted on a substrate) to be manufactured due to a variation of the crystal oscillator and a variation of a capacity of capacitor used for the oscillation circuit or the like (normally, referred to as a free run condition).

The broadcasting receiving apparatus according to the invention uses the basic CLK of the VCXO circuit upon the encode processing in the encoder processing of the MPEG 2, so that even in the free run condition, it is necessary to control the deviation of the oscillation frequency of the VCXO circuit 209 to ±30 ppm.

According to the invention, for example, upon a test of a unit on a factory shipment, a digital broadcasting signal generated as the basic signal is inputted in the tuner section of the unit to generate a reference signal and the reference signal is stored in a memory area. The digital broadcasting signal in this case is MPEG-encoded and is modulated into a digital broadcasting wave (an OFDM signal) with the variation of the PCR value controlled not more than 2 ppm.

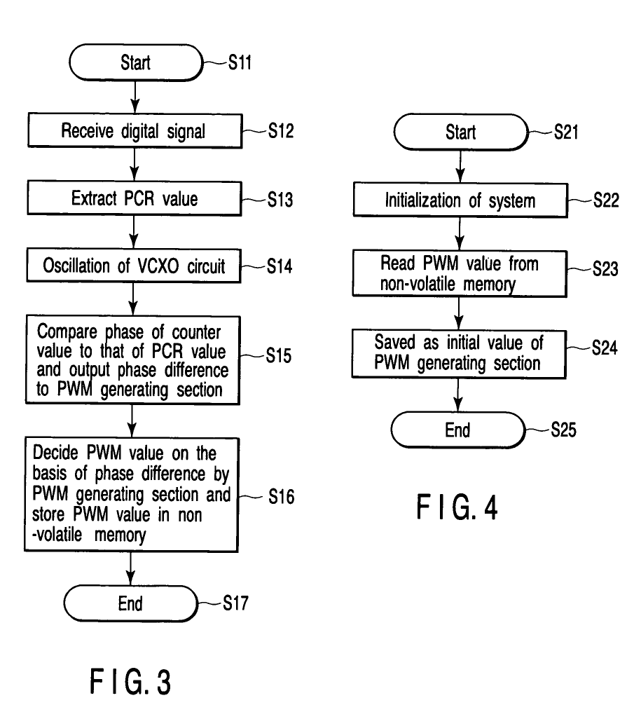

Next, with reference to FIG. 3, an adjustment routine of an oscillation frequency of the present invention will be described below. As shown in FIG. 3, the adjustment of the oscillation frequency is started (S11). Subsequently, on the factory shipment or the like, the digital broadcasting signal is inputted for each apparatus as the digital signal for reference. The inputted signal is inputted in the TSP processing section 201 of the signal processing section 47 via the tuner section (S12).

Subsequently, the PCR value is extracted from the received TS signal by the TSP processing section 201 of the signal processing section 27 (S13). Then, as described above, the PCR value extracted by the TSP processing section 201 is inputted in the VCXO oscillation circuit 207 via the PCR value storage register 202, the phase comparing section 204, and the PWM generating section 203 to be VCXO-oscillated (S14). In other words, the TSP processing section 201 reads the PCR value, and the VCXO oscillation circuit 207 generates an oscillation frequency (CLK) at a value near to the PCR value with respect to the value of which phase is compared to the PCR value and of which PWM is generated.

Subsequently, the oscillation frequency (CLK) is inputted in the STC counter 205 to be compared to the PCR value. In this case, if there is an error, the PWM of which error is corrected is generated (S15). The PWM value acquired in this time is stored in the non-volatile memory 64 that is connected to the signal processing section 47 (S16). With respect to the PWM value to be stored in the non-volatile memory 64, basically, rewriting is not assumed. Thus, the adjustment of the VCXO oscillation circuit 207, which is carried out upon the test of the unit is terminated (S17).

Next, with reference to FIG. 4, the operation upon receiving the analog broadcasting of the present invention in the real TV set operation will be described below.

Then, a system of the receiving apparatus is initialized (S22). Upon initialization of the signal processing section 47, the adjusted PWM value on the factory shipment as described in FIG. 3 is read from the non-volatile memory 64 (S23).

Subsequently, the read PWM value is saved as the initial value of the PWM generating section 203 (S24) to terminate the processing (S25). The PWM generating section 203 outputs a signal in accordance with the PWM value and the VCXO circuit 209 can be always operated in accordance with the center frequency.

If the apparatus can receive the digital broadcasting, the PCR value is always updated in the TSP to be operated, so that it is not necessary to read the PWM stored in the non-volatile memory 64.

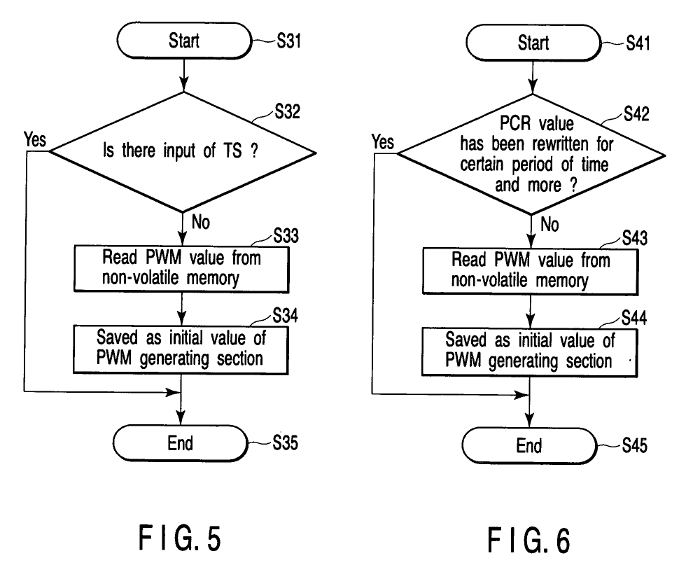

As shown in the flow charts in FIGS. 5 and 6, when the electronic wave cannot be received due to a reception difficulty or the like in the digital broadcasting, and when a signal line is pulled out in the middle (NO in S32 of FIG. 5), or when the input detection of the TS or update of the PCR value is not carried out for a certain period of time in the TSP (NO in S42 of FIG. 6), reading the PWM value stored in the non-volatile memory 64 (S33 in FIG. 5 and S43 in FIG. 6), the initial value is saved in the PWM generating section 203 (S34 in FIG. 5 and S44 in FIG. 6).

Thus, when the digital signal cannot be received, namely, when the analog broadcasting should be received, it is possible to always operate the PWM generating section 203 due to the data of reading the PWM value that is set in the unit step of a factory so as to acquire a center frequency in the VCXO circuit 209.

According to the invention, recording the PWM value when the VCXO control is carried out from the PCR value in the memory area on the factory shipment, upon encoding the analog broadcasting in the MPEG 2 in fact, reading the corrected value of the memory area, the VCXO circuit is controlled. Thus, it is possible to tune the analog signal to a center value of 27.0 MHz that is a standard of the MPEG 2 and the present broadcasting receiving apparatus can receive the analog broadcasting in a good condition.

In the meantime, the present invention is not limited to the above-described embodiment as it is and in execution phase, structural elements can be variously modified within a range not departed from a spirit of the present invention. In addition, by appropriately combining a plurality of structural elements disclosed in the above-described embodiment, various kinds of inventions can be made. For example, some structural elements may be deleted from all structural elements indicated in the embodiment. Further, the structural elements in a different embodiment may be appropriately combined.

What is claimed is:

1. A broadcasting receiving apparatus comprising:
a receiving section configured to receive a digital broadcasting signal;
a processing section configured to recover and reproduce a program from the digital broadcasting signal received by the receiving section;
a display section configured to display the program recovered by the processing section;
a PCR processing section configured to extract a PCR value from a TS signal;
a phase comparing section that is configured so that the PCR value extracted from the PCR processing section is inputted therein to be compared to a counter value of 42 bits;
a PWM generating section that is configured so that the phase difference is inputted from the phase comparing section to generate a PWM value; and
a memory configured to store the PWM value generated by the PWM generating section therein.

2. A broadcasting receiving apparatus according to claim 1,
wherein the broadcasting receiving apparatus reads the PWM value stored in the memory and uses it as a reference signal.

3. A broadcasting receiving apparatus according to claim 1, further comprising a VCXO circuit of reading the PWM value stored in the memory when receiving an analog signal, setting the PWM value as an initial value of the PWM generating section, and oscillating an oscillation frequency for an MPEG on the basis of a signal inputted from the PWM generating section.

4. A broadcasting receiving apparatus according to claim 3,
wherein the broadcasting receiving apparatus detects whether or not there is a TS signal to be inputted in the processing section in order to determine whether it should receive the analog signal or not, and if there is no TS signal, the broadcasting receiving apparatus determines that it should receive the analog signal.

5. A broadcasting receiving apparatus according to claim 3,
wherein the broadcasting receiving apparatus detects whether the PCR value has not been rewritten for a predetermined period of time and more or not in order to determine that it should receive the analog signal, and if the PCR value has not been rewritten for the predetermined period of time and more, the broadcasting receiving apparatus determines that is should receive the analog signal.

6. A method of generating a reference signal of a broadcasting receiving apparatus, comprising:
a first step of receiving a digital broadcasting signal;
a second step of recovering and reproducing a program from the digital broadcasting signal received in the first step;
a third step of displaying the program recovered in the second step;
a fourth step of extracting a PCR value from a TS signal;
a fifth step of comparing a phase of the PCR value extracted in the fourth step to a phase of a counter value of 42 bits;
a sixth step of generating a PWM value on the basis of a phase difference acquired in the fifth step; and
a seventh step of storing the PWM value generated in the sixth step to a memory.

7. A method of generating a reference signal of a broadcasting receiving apparatus according to claim 6,
wherein the broadcasting receiving apparatus reads the PWM value stored in the memory and uses it as a reference signal.

8. A method of generating a reference signal of a broadcasting receiving apparatus according to claim 6, further comprising an eighth step of reading the PWM value stored in the memory when receiving an analog signal, setting the PWM value as an initial value of the PWM generating section in the sixth step, and oscillating an oscillation frequency for an MPEG on the basis of this PWM value.

9. A method of generating a reference signal of a broadcasting receiving apparatus according to claim 8, wherein the broadcasting receiving apparatus detects whether or not there is a TS signal to be processed in the second step in order to determine whether it should receive the analog signal or not, and if there is no TS signal, the broadcasting receiving apparatus determines that it should receive the analog signal.

10. A method of generating a reference signal of a broadcasting receiving apparatus according to claim 8, wherein the broadcasting receiving apparatus detects whether the PCR value has not been rewritten for a predetermined period of time and more or not in order to determine that it should receive the analog signal, and if the PCR value has not been rewritten for the predetermined period of time and more, the broadcasting receiving apparatus determines that it should receive the analog signal.
